(19) United States
(12) Patent Application Publication
(10) Pub. No.: US 2009/0113328 A1
(43) Pub. Date: Apr. 30, 2009

(54) Multidimensional Multistate User Interface Element

(75) Inventor: Sean Leonard, Sacramento, CA (US)

Correspondence Address: KNOBBE MARTENS OLSON & BEAR LLP, 2040 MAIN STREET, FOURTEENTH FLOOR, IRVINE, CA, 92614, US

(73) Assignee: Penango, Inc., Sacramento, CA (US)

(21) Appl. No.: 12/262,131

(22) Filed: Oct. 30, 2008

Related U.S. Application Data
(60) Provisional application No. 60/983,618, filed on Oct. 30, 2007.

(51) Int. Cl. G06F 3/048

(52) U.S. Cl. 715/765

(57) ABSTRACT

Embodiments of the present invention provide multistate, multidimensional user interface elements. In one embodiment, the user interface elements are multistate and multidimensional to indicate to a user of a computer system multiple independently variable states through a single user interface element. The user can change at least one subset of those variable states through the user interface element. The user interface elements may also communicate the behavior that a system will exhibit when acting upon those combined states. Exemplary embodiments include indicating ways in which messages will be processed in a secure messaging system.

### CROSS-REFERENCE TO RELATED APPLICATIONS

This application claims priority to U.S. Provisional Patent Application No. 60/983,618 filed on Oct. 30, 2007, entitled “Multidimensional Multistate User Interface Element,” by Sean J. Leonard, which is incorporated herein by reference in its entirety.

### BACKGROUND

1. Field

This invention relates to graphical user interface methods and systems, and more particularly, to multistate user interface elements.

2. Description of the Related Art

Conventional software applications typically employ a variety of user interface elements to help guide user interaction. For example, most software applications will employ icons or “widgets” as part of their graphical user interface (“GUI”).

A widget is an element of a GUI that displays an information arrangement changeable by the user. Widgets provide a single interaction point for the manipulation or configuration of a specific part of an application. Various types of widgets are well known, such as toggle buttons, check boxes, radio buttons, list boxes, sliders, icons, ribbons, etc.

Unfortunately, due to their small size, conventional widgets are limited in the number of states that they utilize. In particular, conventional widgets generally have only three states at most, such as, on, off, and disabled. The on and off states are generally indicated by displaying different versions of the widget, such as open lock icon and a closed lock icon or different colors. If a widget is in a disabled state, it is generally indicated by being displayed with a shadowed or grayed-out effect as its state.

### BRIEF DESCRIPTION OF THE DRAWINGS

FIG. 1 shows an exemplary system in which the embodiments may be implemented.

FIGS. 2A-D show the conventional user interface of Microsoft Outlook Express.

FIGS. 3A-C, 4A-D and 5A-C show the conventional user interface of Apple Mail.

FIGS. 6A-B show examples of conventional user interface elements.

FIGS. 7, 8A-C, and 9A-D show conventional user interface elements for a mail application of the Mozilia/MachV project.

FIG. 10 conceptually shows an embodiment of the invention as a composite state diagram for a multidimensional multistate user interface element.

FIG. 11 conceptually shows another embodiment of the invention as composite state diagram for a multidimensional multistate user interface element.

FIGS. 12A-D show an exemplary embodiment of a multistate multidimensional user interface element where the composite states represent whether a message will be encrypted when sent by a messaging application.

FIG. 13 shows the exemplary embodiment of the multistate multidimensional user interface element as implemented in a GUI for a secure webmail application.

FIGS. 14 through FIG. 16 illustrate various indicators that may be employed in the multistate multidimensional user interface element.

FIGS. 17 through FIG. 25 represent embodiments the multistate multidimensional user interface element where the composite states represent whether a message will be digitally signed when sent by a messaging application.

### DETAILED DESCRIPTION OF EMBODIMENTS

Embodiments of the present invention provide multistate, multidimensional user interface elements. In one embodiment, the user interface elements are multistate and multidimensional to indicate to a user of a computer system multiple independently variable states through a single user interface element. The user can change at least one subset of those variable states through the user interface element. The user interface elements may also communicate the behavior that a system will exhibit when acting upon those combined states. Exemplary embodiments include indicating ways in which messages will be processed in a secure messaging system.

Reference will now be made in detail to the exemplary embodiments of the invention, which are illustrated in the accompanying drawings. Wherever possible, the same reference numbers will be used throughout the drawings to refer to the same or like parts.

For purposes of illustration, embodiments of the multistate, multidimensional user interface elements are explained for implementation with a secure messaging application, such as an e-mail, or webmail application. However, one skilled in the art will recognize that the embodiments can be employed in other types of messaging applications, or various other types of applications.

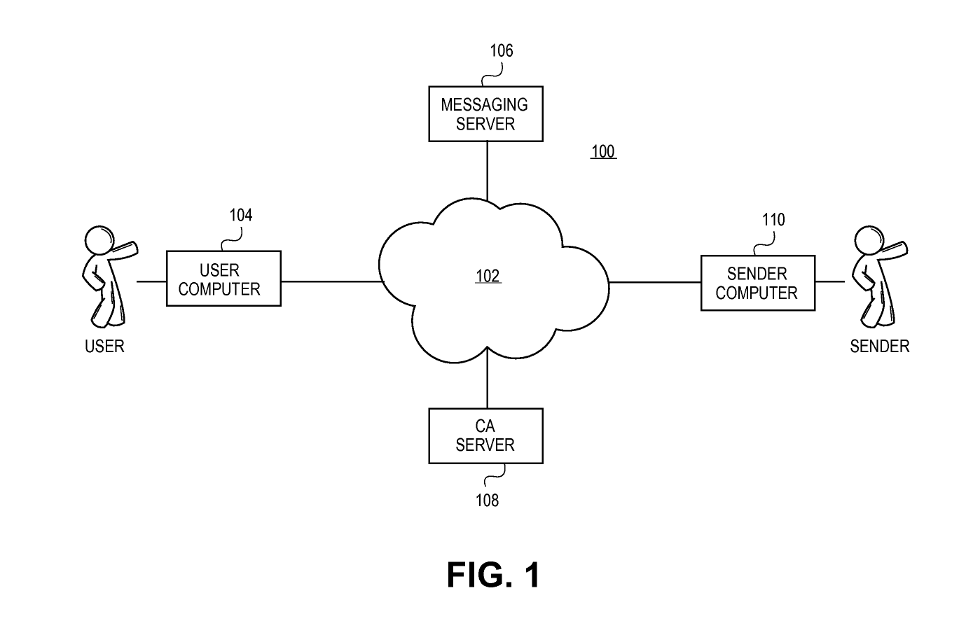

FIG. 1 shows an exemplary system consistent with embodiments of the present invention. FIG. 1 is intended as an example, and not as an architectural limitation for the embodiments described. As shown, a system 100 may comprise a network 102, a user computer 104, a messaging server 106, a CA server 108, and a sender computer 110 that is operated by a sender. These components will now be further described below. System 100 may include, however, additional servers, clients, and other devices not shown.

Network 102 serves as a communication infrastructure to support the communications between the other components of system 100, such as user 104, messaging server 106, and CA server 108. Such networks are well known to those skilled in the art including local area networks, metropolitan area networks, wide area networks, mobile communications networks (such as 3G networks), WiFi networks, and the like. In some embodiments, network 102 may comprise one or more networks of the Internet.

User computer 104 provides the hardware and software for a user to utilize the methods and systems of the embodiments. The user computer 104 may be implemented on well known devices, such as, personal computers, network computers, mobile phones, laptops, and the like. In the depicted example, user computer 104 may comprise the hardware, software and data (not shown), such as processors, memory, storage systems, boot files, operating system images, and applications (like a browser and browser extension). Furthermore, the user computer 104 may employ the Transmission Control Protocol/Internet Protocol (TCP/IP) suite of protocols to communicate with the other components of system 100.

Messaging server 106 provides services, for example, to user 104 related to messaging. For example, messaging server 106 may be one or more servers that implement an e-mail application. Such servers are well known to those skilled in the art. Of course, messaging server 106 may provide other services, such as account management, or other forms of messaging. In some embodiments, messaging server 106 may relate to well known e-mail services, such as Microsoft Exchange, or webmail services, such as Yahoo! Mail, Gmail, and the like.

In the depicted example, messaging server 106 may comprise the hardware, software and data (not shown), such as processors, memory, storage systems, boot files, operating system images, and applications (like a web server). Furthermore, the messaging server 106 may employ the TCP/IP suite of protocols to communicate with the other components of system 100.

CA server 108 can serve as a third party that is trusted by both the user computer 104 and other entities of system 100, such as the sender, sender computer 110, etc. For example, user computer 104 and sender computer 110 may rely on the CA server 108 for attestations of particular kinds, for example, confirming each computer's identity and providing public keys of each computer, but not necessarily the user or the sender. In general, the CA server 108 confirms that each computer is in fact who they say they are and then provides the public keys of each computer to the other. In some embodiments, the CA server 108 provides digital certificates and a PKI system that allows the user computer 104 and messaging server 106 to secure his or her messaging. For example, in some embodiments, the services of CA server 108 may enable the use of Secure/Multipurpose Internet Mail Extension (S/MIME) by user 104 with a webmail application provided by messaging server 106.

In the depicted example, CA server 108 may comprise the hardware, software and data (not shown), such as processors, memory, storage systems, boot files, operating system images, and applications (like a web server). Furthermore, the CA server 108 may employ the TCP/IP suite of protocols to communicate with the other components of system 100.

Sender computer 110 provides the hardware and software for a sender to utilize the methods and systems of the embodiments. The sender computer 110 may be implemented on well known devices, such as, personal computers, network computers, mobile phones, laptops, and the like. In the depicted example, user computer 110 may comprise the hardware, software and data (not shown), such as processors, memory, storage systems, boot files, operating system images, and applications (like a browser and browser extension). Furthermore, the user computer 104 may employ the Transmission Control Protocol/Internet Protocol (TCP/IP) suite of protocols to communicate with the other components of system 100. As will be explained in more detail below, the user computer 110 may utilize various embodiments of multistate, multidimensional user interface elements to help the user interact with his or her secure messaging application, such as a webmail application running via a browser, or an e-mail client.

Sending and receiving encrypted and signed (that is, authenticated) messages is a capability well-known in the art. Yet despite over a decade of software and services available in the e-mail arena, the use of technologies, such as S/MIME and Pretty Good Privacy (PGP), is not widespread. One of the reasons for this lack of acceptance is the complexity of the conventional messaging applications when they employ encryption and digital signatures. Thus, the overwhelming majority of e-mail messages are sent unencrypted and unsigned. Many user interfaces offer methods by which a user can choose to sign or encrypt a message in conjunction with composing the message.

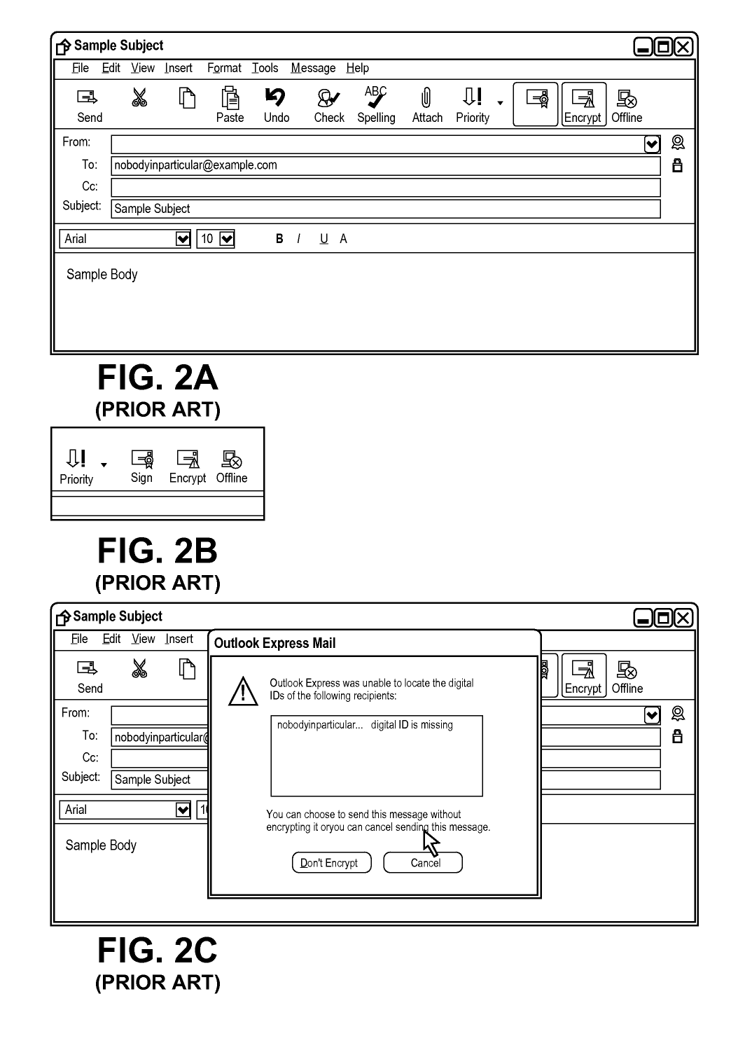

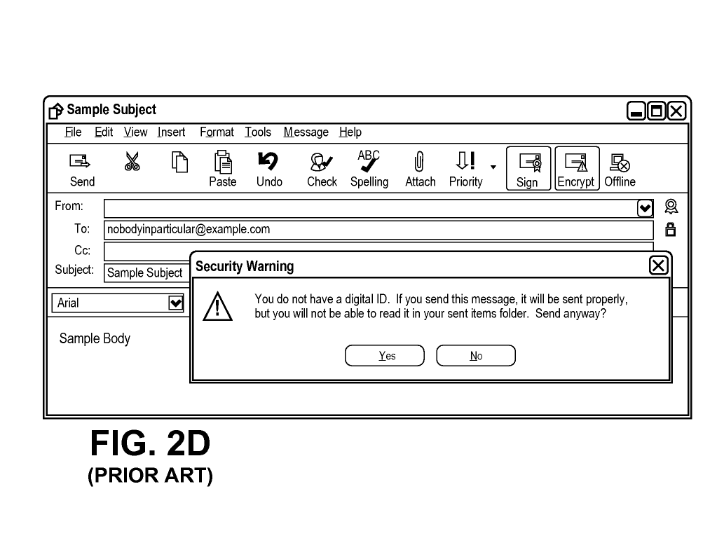

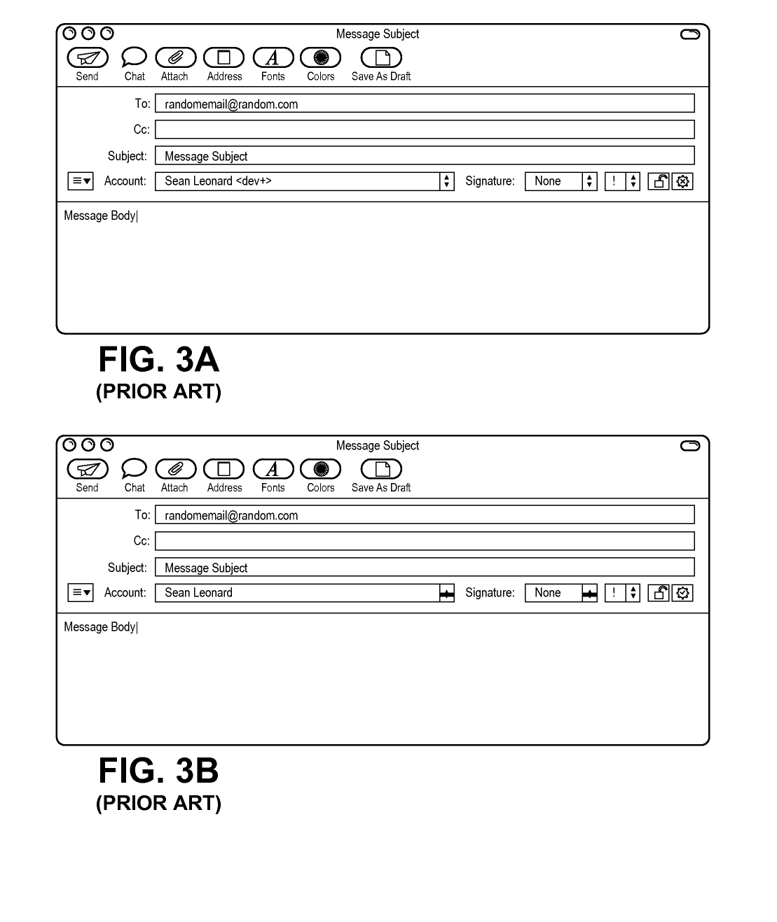

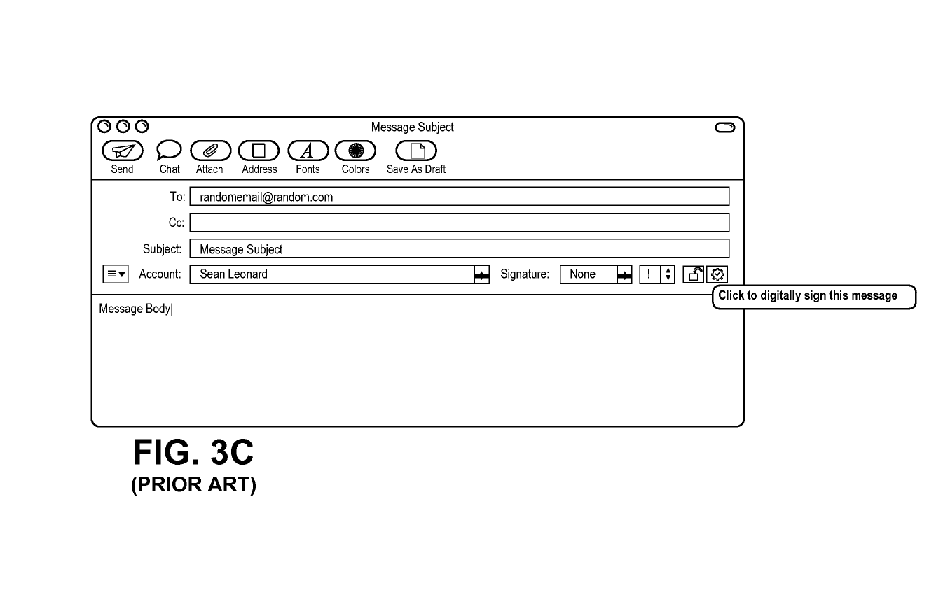

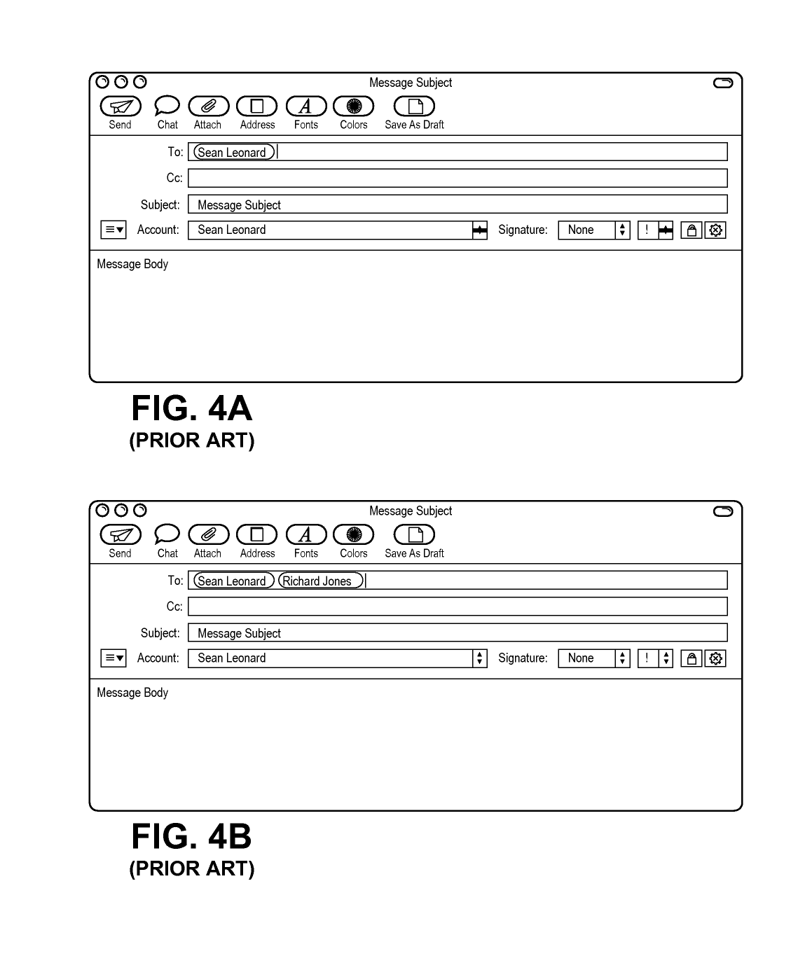

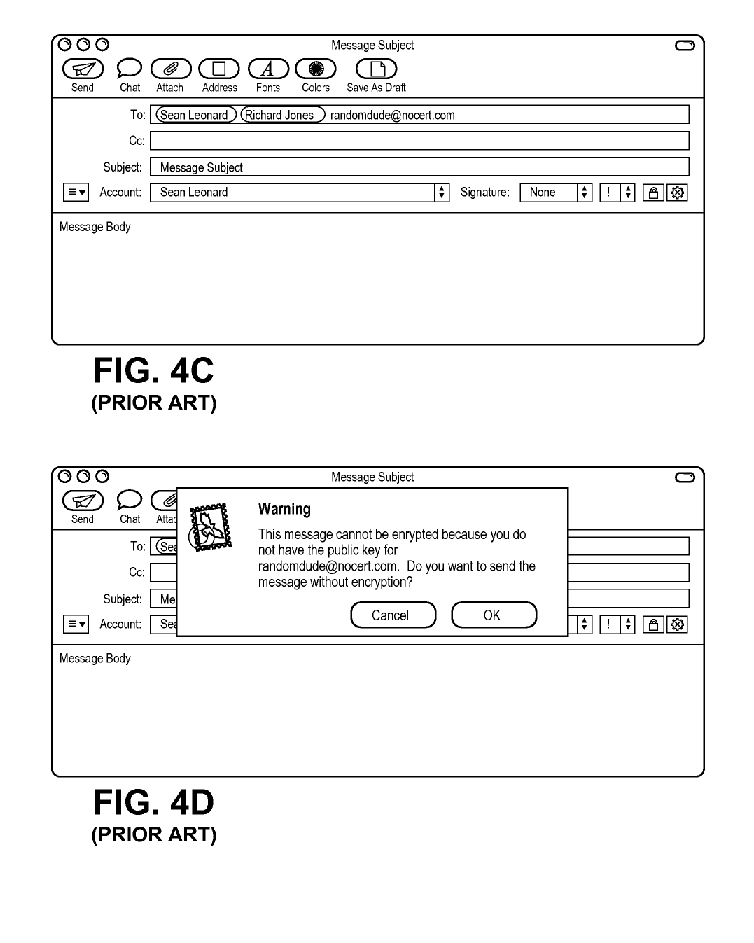

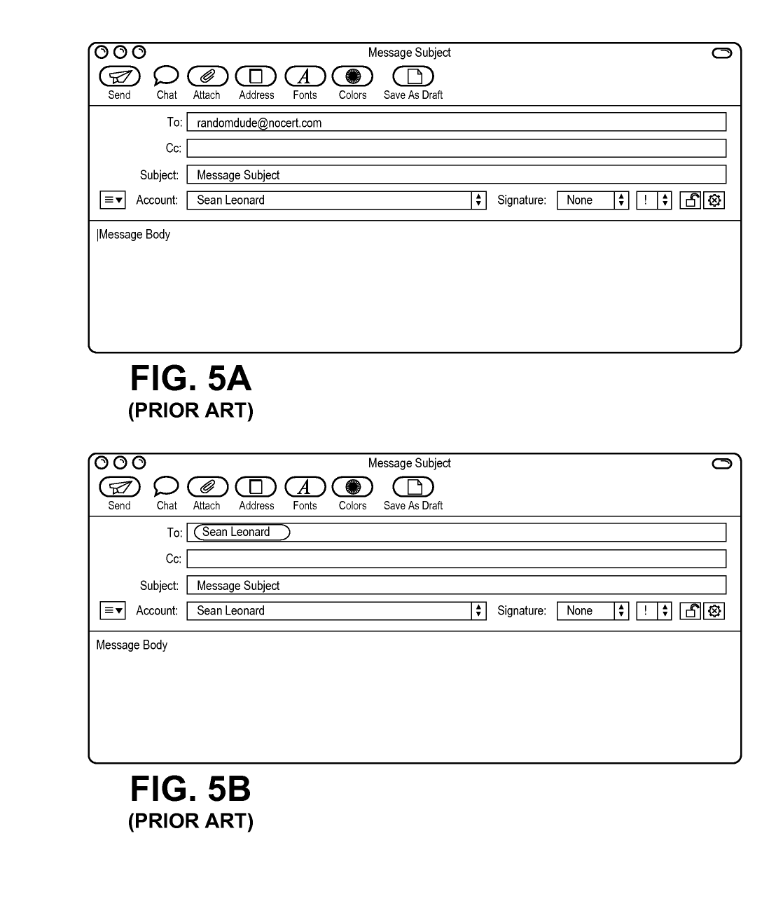

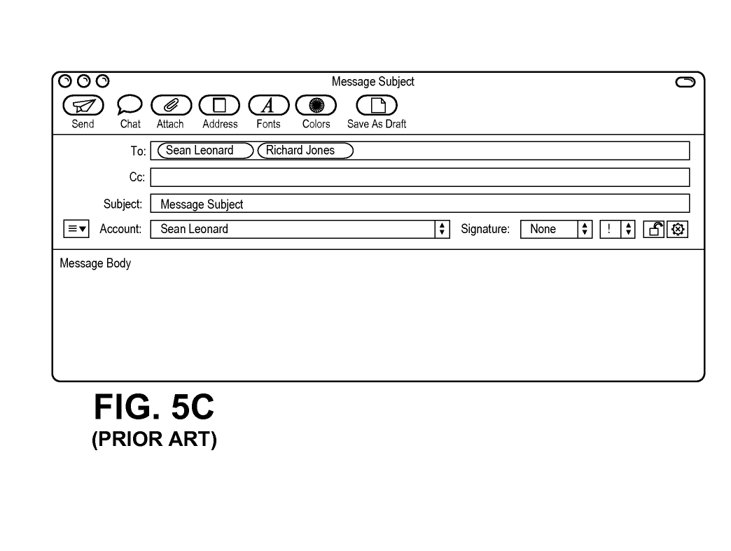

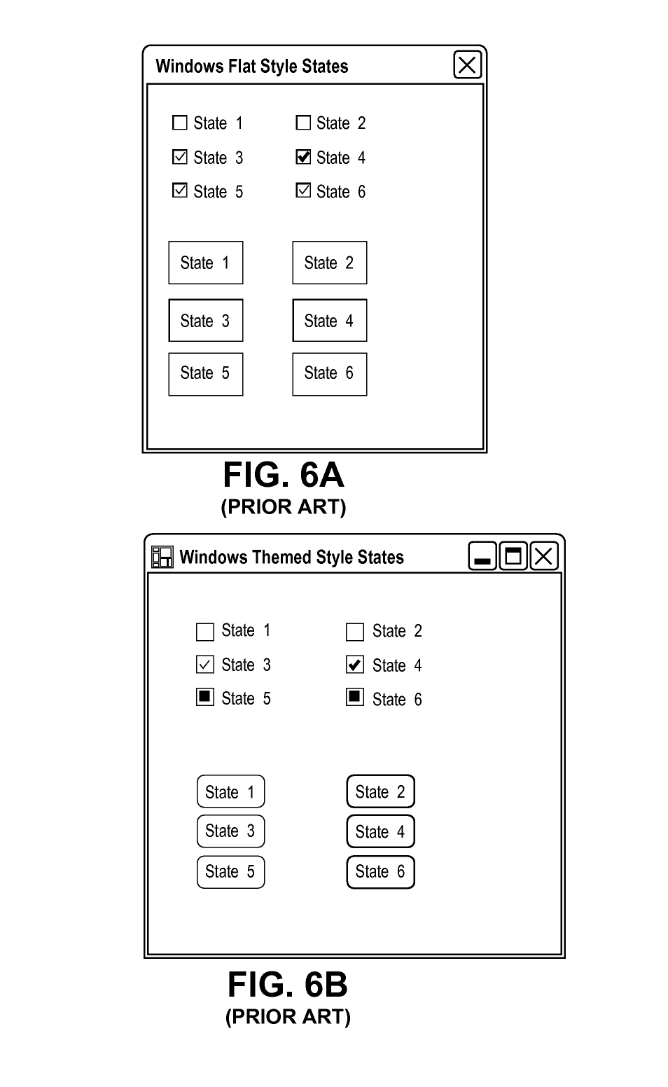

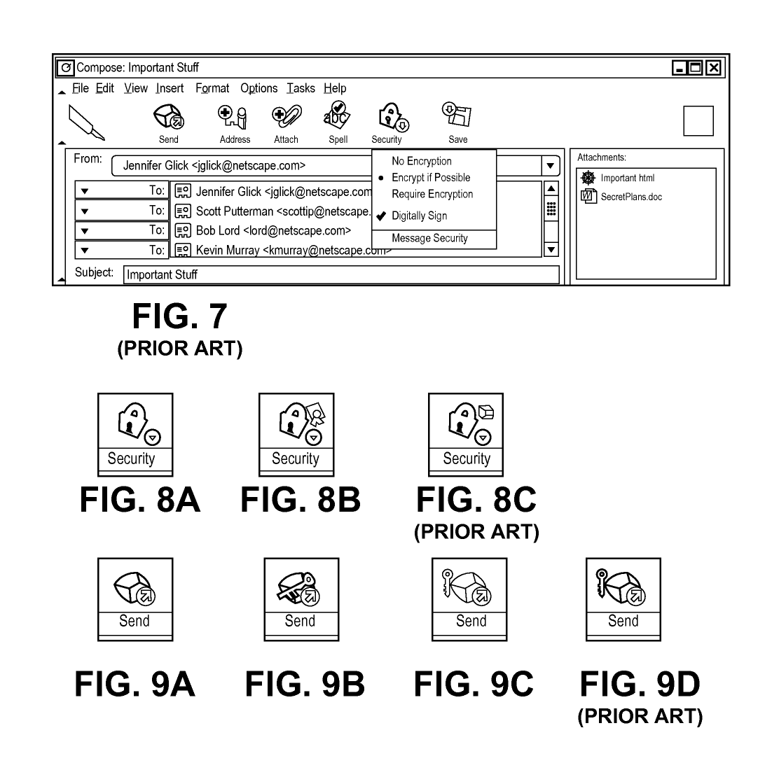

In order to better understand the failings of the conventional user interfaces, some conventional messaging applications will now be described with reference to FIGS. 2-9. FIGS. 2A-D show the conventional user interface of Microsoft Outlook Express. FIGS. 3A-C, 4A-D and 5A-C show the conventional user interface of Apple Mail. FIGS. 6A-B show examples of conventional user interface elements. FIGS. 7, 8A-C, and 9A-D show conventional user interface elements for a mail application of the Mozilia/MachV project.

Referring now to FIGS. 2A-D, the conventional user interface of Microsoft Outlook Express is shown. As explained further below, the user interface elements employed by Outlook Express are limited. For example, as shown in FIG. 2A, a user has indicated in the From line that he or she wishes to us a digital certificate and private key to send messages. In particular, the user selects Sign and Encrypt from the toolbar. In FIG. 2A, the user has typed an e-mail address where the recipient has no known digital certificate. When Sign or Encrypt are not selected, they appear as shown in FIG. 2B.

In FIG. 2C, the user has clicked Send (an action button), but is presented with a dialog box reciting “Outlook Express was unable to locate the digital IDs of the following recipients.” Thus, the user is inconveniently prompted to press “Don't Encrypt” or “Cancel” before sending the message.

As another example, in FIG. 2D, the user has indicated in the From line the sender does not have a corresponding digital certificate and private key combination with which to send messages. Yet, the Sign button can still be (and still is) selected. Thus, when the user clicks Send, the dialog box reciting “You do not have a digital ID . . . ” is presented. The user is then inconveniently prompted to press “Yes” or “No” before sending the message.

Referring now to FIGS. 3A-C, 4A-D and 5A-C, the conventional user interface of Apple Mail is shown. In Apple Mail, the last preferences as to whether the user indicated to sign or encrypt the previous message are used as the basis for the following message. As shown, the Sign and Encrypt buttons each have three composite states. The Encrypt button has: (1) a disabled state wherein the button appears unselected, the lock icon appears unlocked, and the entire element appears faded; (2) an enabled and off state wherein the button appears unselected, the lock icon appears unlocked, and the entire element appears in well-contrasted dark and light shades; and (3) an enabled and on state wherein the button appears selected, the lock icon appears locked, and the entire element appears in well-contrasted dark and light shades.

The Sign button has: (1) a disabled state wherein the button appears unselected, the rosette or circular seal (or “blob”) appears with an X, and the entire element appears faded; (2) an enabled and off state wherein the button appears un selected, the blob appears with an X, and the entire element appears in well-contrasted dark and light shades; and (3) an enabled and on state wherein the button appears selected, the blob appears with a checkmark, and the entire element appears in well-contrasted dark and light shades.

In FIG. 3A, the Sign button is disabled because the account shown in the Account combo box does not have a corresponding digital certificate and private key combination with which to send messages. In FIG. 3B, the user selects an account that has a corresponding digital certificate and private key combination. The Sign button is enabled and selected. In FIG. 3C, the user selects an account that has a corresponding digital certificate and private key combination. The Sign button is enabled, but not selected. In both FIG. 3B and FIG. 3C, the user may click the Sign button to select or deselect it. Yet FIG. 3B and FIG. 3C both follow from FIG. 3A, and thus, the user cannot determine his or her prior preference if, for example, he forgot what was previously indicated, or if the system set the preference initially. Therefore, the limited nature of Apple Mail's user interface elements have potentially confused the user regarding his or her preferences for a message.

FIGS. 4A-D show the state of the Encrypt button when recipients are entered into the To line. When no recipients are present or when a recipient without a known digital certificate is present, the Encrypt button is disabled. In FIG. 4A, a recipient with a known digital certificate is present, and the Encrypt button becomes enabled. The Encrypt button shows that it is selected. In addition, when a second recipient with a known digital certificate is entered as shown in FIG. 4B, the Encrypt button remains enabled and selected.

But, when a third recipient without a known digital certificate is entered as shown in FIG. 4C, the Encrypt button remains enabled selected. Thus, when the user clicks the Send button at the top left, the dialog box of FIG. 4D indicating “The message cannot be encrypted” is presented. Therefore, the limited nature of Apple Mail's user interface elements have allowed the user to request an incorrect action.

Referring now to FIG. 5A (no digital certificate), FIG. 5B (digital certificate), and FIG. 5C (two digital certificates), these figures illustrate how a user viewing the disabled Encrypt button of FIG. 5A cannot tell whether the button, when enabled, will transform to FIG. 5B-C or to FIG. 4A-B due to the limited nature of the user interface elements.

Referring now to FIGS. 6A-B, examples of one-dimensional user interface elements used in Microsoft Windows XP are shown. In particular, one-dimensional check boxes and buttons are shown. As shown in FIGS. 6A-B, State 1 and State 2 are deselected; State 3 and State 4 are selected; State 5 and State 6 are in an “indeterminate” third state. State 1, State 3, and State 5are shown in disabled user interface elements (grayed out); and State 2, State 4, State 6 are shown in enabled user interface elements (in full color or contrast).

In FIG. 6A, the interface elements are drawn in the Windows “standard” style. In FIG. 6B, the interface elements are drawn in the Windows “themed” style. As can be seen in FIG. 6A, the check boxes in State 3 and State 5 are not readily distinguishable. In addition, as shown in FIG. 6B, the toggle buttons in State 3 and State 5 are not readily distinguishable.

In Windows XP, by design, disabled elements cannot be activated, nor can their states be manipulated by the user. Thus, the disabled state is a particular kind of user interface state that restricts the user's ability to manipulate the underlying program states represented by the user interface element. This feature can create confusion and inconvenience for the user in various situations. As will be explained below, embodiments of multistate multidimension user interface elements can avoid these problems.

FIG. 7 through FIG. 9 show proposed user interface elements for the Mail application of the Mozilia/MachV project. In particular, FIG. 7 shows the context of toolbar buttons in the user interface, including the Send button and the Security button. FIG. 8A-C show a one-dimensional multistate action button in three different states: (1) no certificates or unknown certificates because the user does not intend to encrypt: “No icon on Security button” (as shown in FIG. 8A); (2) a “Security toolbar icon indicates that a valid certificate for each recipient was found” (as shown in FIG. 8B); and (3) “The toolbar Security icon indicates that valid certificates were not found for all recipients” (as shown FIG. 8C). As can be seen from FIGS. 8A-C, these user interface elements are still one-dimensional in nature.

Referring now to FIGS. 9A-D, a one-dimensional action button in four different states is shown. In particular, disabling (as shown in FIG. 9C) or enabling (as shown in FIGS. 9A, B, D) can be expressed as the result of certain other program parameters, including the user's prior preference or management policy. Thus, the state of the buttons reflect what the user can expect to occur when Send, an action button, is clicked, but the user has no ability to manipulate the state through said Send button. For example, if the user desires “Always” encryption, the messages can NOT be sent if certificates for all recipients are not available. Therefore, the user interface elements of the Mozilla Mail application also suffers from the same disadvantages as other conventional applications.

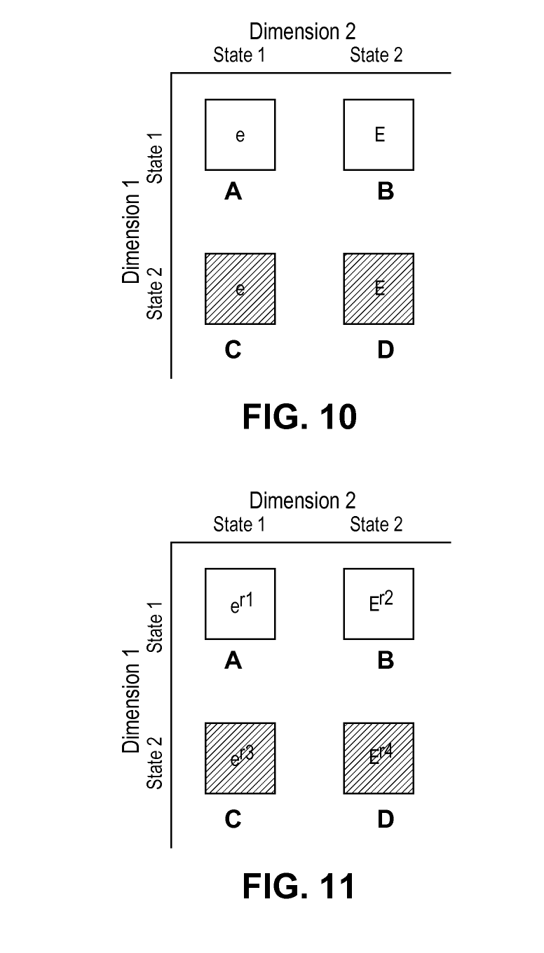

In contrast to the examples of conventional applications above, in an exemplary embodiment, a user interface element can contain multiple states organized along multiple independent (e.g., freely manipulated) dimensions. Referring now to FIG. 10, a composite state diagram is provided to conceptually illustrate a multistate multidimensional user interface element. Each composite state is represented in the user interface element. At least two sources of dimensionality can manipulate their respective state spaces, independently of and therefore without interference from other sources of dimensionality (and hence, from other dimensions). These sources of dimensionality may be data sources or configuration settings requested by the user, the sender computer 110, or the system 100.

As shown, dimension 1 is represented by the coloring of the blocks in FIGS. 10A-B (white) and FIGS. 10C-D (gray). Dimension 2 is represented by the capitalization of the letter “E” in FIGS. 10A, C and FIGS. 10B and D. For convenience, composite states corresponding to positions in the diagram in FIG. 10 are respectively labeled State I (FIG. 10A), State II (FIG. 10B), State III (FIG. 10C), and State IV (FIG. 10D).

As shown in FIGS. 11A-D, composite states may be further embellished by result states, as shown in superscript form as r1-4. A result state can be computed from the combination of the states along the multiple dimensions. A result state may also be represented in the user interface element with a distinct representation.

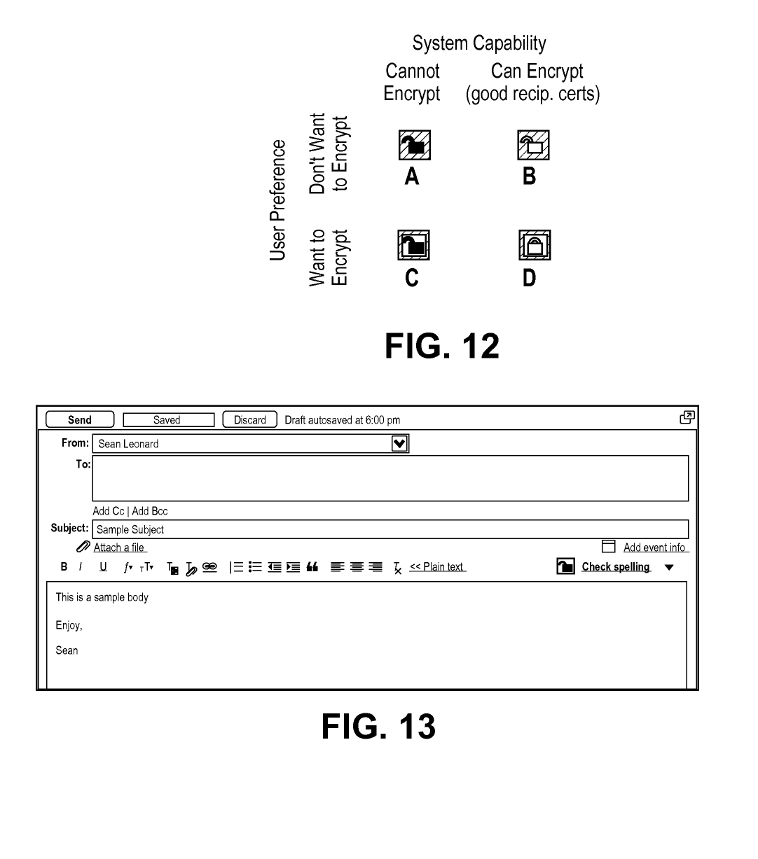

Referring now to FIGS. 12A-D, an exemplary embodiment and its operation are illustrated. As shown, a message in a messaging system may be encrypted for the message's recipients, but whether the message will actually be encrypted can depend on several factors. For example, an e-mail can be encrypted using asymmetric encryption principles under a protocol, such as S/MIME or PGP. To encrypt to recipients, the sender must have all of the public keys of the recipients, and the public keys must be trustworthy, e.g., the sender must assume or determine that the public keys have not expired or been revoked. If the sender only has some of the public keys, the sender may send the encrypted message to some of these recipients and unencrypted message to the remainder. That is, the sender may send only an encrypted message to capable recipients and may send only an unencrypted message to incapable recipients, or may send an unencrypted message to all. However, the sender may wish to send encrypted rather than unencrypted messages by default.

FIG. 12 shows the representations of composite states and result states that show whether and based on which dimensions a message will be encrypted. Dimension 1 is the User Preference dimension, whose data source is the user; said user is presently interacting with the user interface element. Dimension 2 is the System Capability dimension, whose data source is the system (in this case, the e-mail application). In some embodiments, an e-mail application running on sender computer 110 dynamically determines whether appropriate public keys for the recipients are available, and based on these and other parameters (further described below), displays the lock icon in grayscale or in color.

For example, when at least one recipient is listed in the To, Cc, or Bcc line of the e-mail message under composition may not have a valid-trustworthy-digital certificate, or other form of public key. In such a case, the System Capability dimension is set to the Cannot Encrypt state, resulting in the grayscale lock icon of FIG. 16A and FIG. 16C. If the user wishes to send encrypted messages by default, the user can see that the Encrypt button is at least selected by virtue of the User Preference dimension being set to the Want to Encrypt state. Thus, the resultant composite state is State III in this case. FIG. 17 shows an example of how the user interface element might appear in an e-mail interface. In addition, when the user clicks on the button to avoid encrypting the e-mail, then the button will transition to State I.

In another example, perhaps the user does not have a preference about e-mail encryption because he or she does not know whether his or her frequently-mailed recipients have digital certificates. Thus, by default, the user may have the user preference Don't Want to Encrypt Yet. However, when the system detects that all recipients have digital certificates, the button may transitions from State I to State II. The user may then see that if he or she selects the button to transition to State IV, the user will not be presented with an inconvenient dialog box indicating an absence of valid public keying material. This presentation of information may encourage more users to try encrypting e-mail by default. If it is deemed desirable to attract the user's attention, transitions between states can be accompanied with additional fanfare, such as an animation (e.g., zooming) or sound (e.g., an affirmative click sound).

Because the System Capability dimension in this exemplary embodiment can be determined by the underlying e-mail application, the System Capability may change dynamically in response to other events or data. For example, the system 100 or sender computer 110 may gather the results of the recipient lines and dynamically transition to a state as the user changes the addressees. The user's changing of addressees may not necessarily reflect a preference about encryption, but such information may have consequences that the system 100 or sender computer 110 can determine.

In another example, after some time composing a message, a recipient's digital certificate may expire. In such a case, the system 100 or sender computer 110 may transition the System Capability to Cannot Encrypt. In a further example, the system 100 or sender computer 110 may query a public key directory for a recipient's public key (or digital certificate), or may query a certificate authority for whether that recipient's digital certificate has been revoked. Upon receiving new information the system 100 or sender computer 110 would update the System Capability, without modifying or hiding the user's preference.

In yet another example, when a new message is first started. A user can type information into the body, but leave the recipient lines empty. In some embodiments, the e-mail application may save the message as a draft. The messaging application considers the user to be an implicit recipient of the message. Thus, if the user has a digital certificate and private key combination, the System Capability is set to Can Encrypt and the lock icon is colored. If the user has expressed a User Preference of Want to Encrypt, the composite state is State IV as indicated in FIG. 12D, and therefore the e-mail draft will be saved encrypted for that user alone using the user's public key.

In an alternative embodiment, the messaging application considers the User Preference dimension as “User Preference to Avoid Any Divulging of Message Contents to Any Third Party,” and treats System Capability as meaning “System Capability to Encrypt E-Mail to Recipients besides the User.” Thus, if the user's preference is Want to Encrypt, the composite state is State III, but the application will still encrypt the e-mail when saving the draft copy on the e-mail server. In yet another alternative embodiment, the application may expose more than two states per each dimension: System Capability may include a third “Can Encrypt for All Recipients but the User” state. Further Indicators and Dependent Dimensionalities

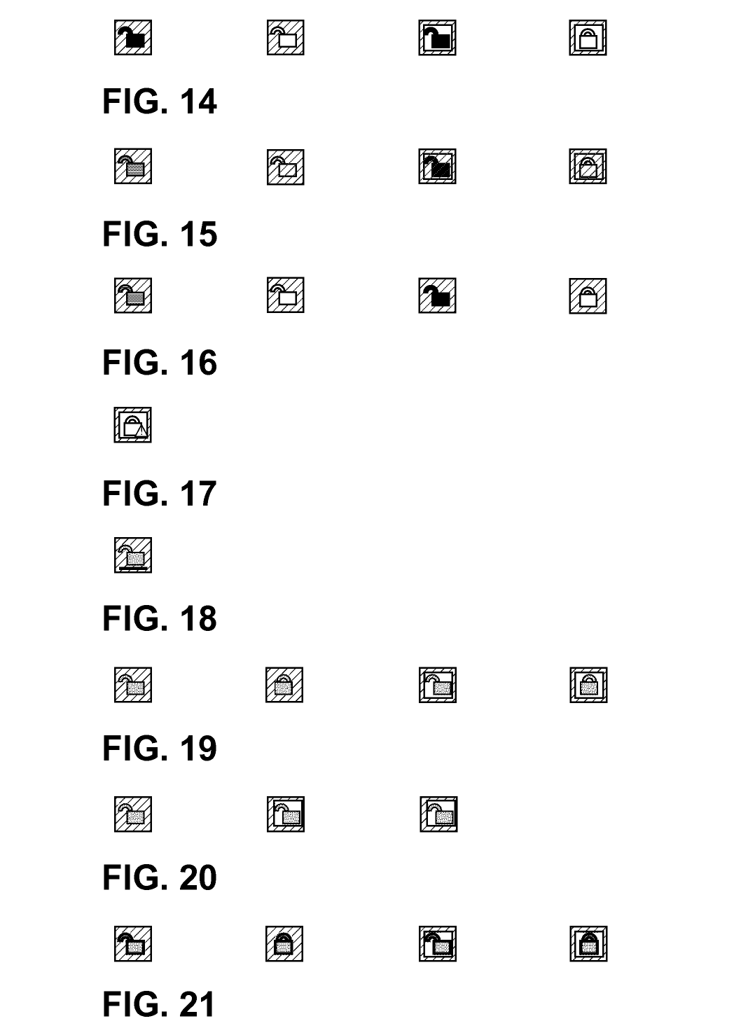

FIGS. 13 through FIG. 21 illustrate a examples of other visual indicators that may be used to represent dimensions and states of user interface elements consistent with the present invention. Icon overlays (as shown in FIG. 17), lines (such as underlines shown in FIG. 18), drop shadows (as shown in FIG. 19), horizontal, vertical, and diagonal gradients (as shown in FIG. 20), and outer glows (as shown in FIG. 21) can all represent the presence or absence of particular states. These states may form independent dimensions or may consist of result states based on existing dimensions. In one embodiment, the red exclamation overlay (as shown in FIG. 17) warns the user that while the system is capable of encrypting, and while the user wishes to encrypt, encrypting is not recommended due to some other observed trait. For example, one of the recipients may have a weak 40-bit key. Such a use occurs in a result state space since the use of the indicator may be computed from the existing dimensional variables.

Some indicators may cause seemingly independent dimensions to become dependent, or may otherwise themselves be dimensionally dependent. Consider the use of transparency as an indicator in FIG. 14 through FIG. 16. In an exemplary embodiment, an application uses such techniques to indicate, for example, whether a third-party evaluator (such as a management policy) recommends encrypting messages (irrespective of the other two dimensions). Thus, FIG. 14 or FIG. 15 can be combined with FIG. 12 to create a three-dimensional state space with 2³=8 composite states.

In one embodiment, FIG. 16 illustrates distinctions between the User Preference dimension's states that are collapsed, thus keeping the total independent dimensionality at 2. The dimension formerly known as User Preference now may be deemed “Singularity Dimension 1,” comprising three state representations: (A) unselected, (B) selected, and (C) faded out.

The use of transparency or fading may be to indicate the disabled “user interface state.” As discussed above, disabling restricts the user's ability to manipulate the underlying program states represented by the user interface element. Thus, disabling constrains existing dimensions rather than generating new, independent dimensions. This constraint arises because the user is unable to manipulate his or her previously freely manipulated dimension.

By way of example, disabling the encrypt button of FIG. 12 can mean that the user can no longer specify whether he or she wishes to encrypt. As shown in FIG. 16, the user does need to remember whether he or she expressed a particular preference, or whether the user's expressed preference is being taken into account when computing the result. Furthermore, even though the user may see his or her previously preference, for example, through the faded interface of FIG. 14 or FIG. 15, the user cannot manipulate the preference. Thus the two dimensions User Preference and System Capability may collapse to a single “System's Result” dimension with appropriate corresponding states.

A System's Result state may well include a representation about a past choice that the user made. Yet, by disabling the interface through which the user may express the user's present choice, the user's old choice may no longer be called an “independent dimension.” That old choice can be a property of the system's computations, just as the system used to compute System Capability based on the user's past or indirectly relevant choices (of addressees of recipients). When the user interface is disabled, the user may no longer have to express whether now, he or she wishes to encrypt the e-mail.

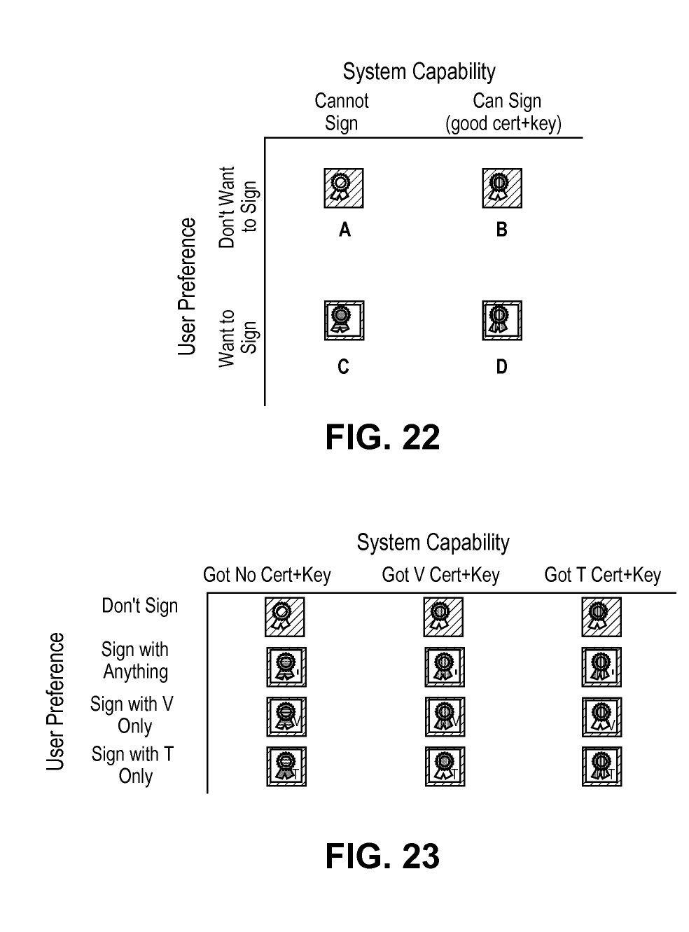

It is a feature of the embodiments described herein that a user interface element that expresses multiple dimensions of states and neither hides dimensions from the user nor prevents the user from freely manipulating dimensions where said dimensions are to reflect the user's present preferences. As noted above, dimensions can have more than two states. For example, the System Capability dimension can represent whether the message can be signed with a digital certificate and private key combination corresponding to a particular identity of the user's choosing; that identity in most circumstances would also correspond to information in the From line of an e-mail message. The result state may be indicated by the coloration and direction of the ribbons beneath the rosette, for example, the result “will sign” is shown with bright red ribbons that hang vertically beneath the rosette as shown in FIG. 22D.

In an exemplary embodiment shown in FIG. 23, the User Preference dimension has four states and the System Capability has three states, corresponding to twelve composite states. In this embodiment, there are two known certificate authorities: V and T. Depending on the materials that the user has at any given moment, the user may have (1) no certificate plus private key, (2) the user's certificate plus private key signed by V, or (3) the user's certificate plus private key signed by T. Such combinations may occur, for example, if the user keeps the V private key on a work computer and the T private key on a home computer, but otherwise accesses the same e-mail service from multiple locations. As the user clicks through the toolbar button, the state transitions from “Don't Sign” to “Sign with Anything” to “Sign with V Only” to “Sign with T Only” and back to “Don't Sign.” Thus, the states combine into resultant composite states, which yield result states as the system computes.

In FIG. 23, four of the twelve states result in a signed message: composite states where the system identifies a V or T certificate plus private key and the user prefers Sign with Anything, and composite states where the system identifies the same certificate plus private key as the user prefers, whether V or T.

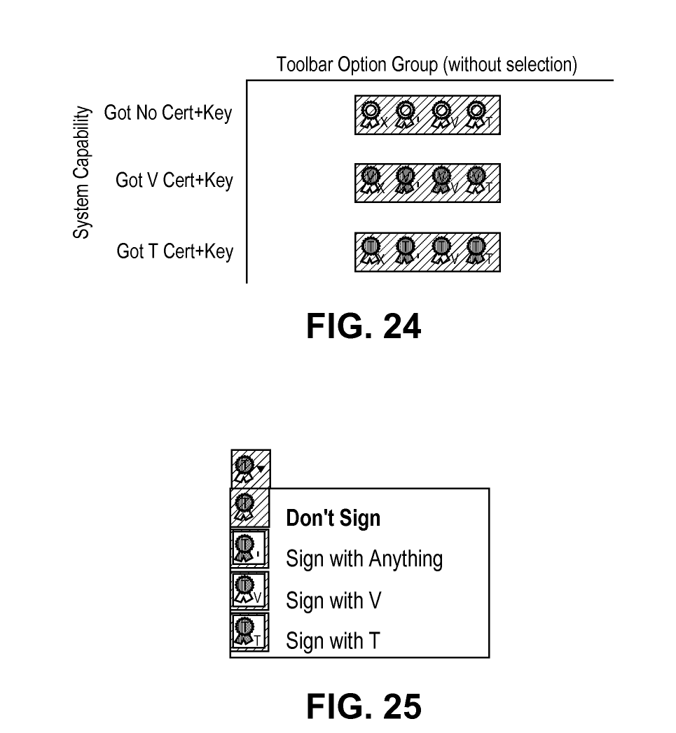

Referring now to FIG. 24, a multidimensional multistate user interface element can also be represented as an option group, such as a sequence of tool bar buttons in an option group. In an implemented embodiment, one of the four elements of each group of FIG. 28 would be selected. In this context, the selection still corresponds to the user's preference among the User Preference dimension's states, but the absence of a selection image may not carry the same meaning (because its absence does not distinguish tool bar buttons from one another). Thus, in place of the absent selection, an X is provided for the Don't Sign preference.

FIG. 59 shows an alternative embodiment multidimensional multistate user interface element. In FIG. 25, the user can pick the User Preference dimension's state from a dropdown menu, rather than clicking the icon successively to cycle through states.

Many other variations are possible, as indicated in the additional embodiments recited above. For example, user interface elements may be constructed along far more than two independent dimensions. Dimensions may include whether Friend 1, Friend 2, Friend 3, Friend 4, Friend 5, and Enemy 1 have signed a particular identity (in a web of trust). Such binary states would be represented as individual flecks of color in the tool bar button. The result (pending some computation weighting each friend and enemy distinctly) would be to include an automatic footer in the e-mail message, while the User Preference dimension would include four states: “want to include footer always,” “want to follow friends and enemies,” “want never to include footer,” and “want to do opposite of friends and enemies.”

For another example, a User Preference dimension may retain its freely manipulated character while being initially set by a system computation. Such a dimension may be deemed Initially Determined but Manipulable User Preference (lDBMUP).

A user may wish that the system determines whether the user should attempt to encrypt an e-mail by default. The system may then perform a computation to make this determination. For example: the system may combine the expressed desires of the recipients of a given message to receive encrypted e-mail, and determines whether encrypting the e-mail will provide any extra value (in view of the presence of a cryptographically secure channel such as SSL/TLS between mail servers). The system may then set the IDBMUP dimension to Want to Encrypt or Don't Want to Encrypt as appropriate. While the system computes the initial state of this dimension, the user still may freely manipulate the testate through the user interface element. Thus, the embodiments of the multistate multidimensional user interface elements can convey more information to the user in a single space, imposes fewer interactive requirements, such as follow-on dialog boxes, or retain the free manipulability of the embodiment while conveying states in multiple dimensions, than other user interface elements previously known in the art. It is intended that the specification and examples be considered as exemplary only. The true scope and spirit of the invention are indicated by the following claims.

What is claimed is:

1. A method for constructing a multidimensional multistate user interface element comprising the steps of:
providing a user interface element;
defining a first dimension comprising a plurality of first states;
defining a second dimension comprising a plurality of second states;
identifying a first data source associated with said first dimension; and
identifying a second data source associated with said second dimension, whereby said first data source can freely manipulate said first dimension by setting said first dimension to one of said first states, said second data source can freely manipulate said second dimension by setting said second dimension to one of said second states, and said set first dimension and said set second dimension are combined into a composite state, wherein said composite state is represented in said user interface element, and wherein said composite state as represented in said user interface element may be distinguished from any other composite state as represented in said user interface element.

2. The method of claim 1 further comprising a result state computed from said composite state, wherein said result state is represented in said user interface element.

3. The method of claim 1 wherein said button appears as a toolbar button.

4. The method of claim 1 wherein said user interface element is presented in a messaging application.

5. The method of claim 4 wherein said user interface element is presented in a messaging application for the purpose of sending digitally signed and encrypted messages.

6. The method of claim 1 wherein each state of said first states of said first dimension specifies a user preference, and wherein said first data source is a user interacting with said user interface element.

7. The method of claim 6 wherein each state of said second states of said second dimension specifies a system capability, and wherein said second data source is a system.

8. The method of claim 7 wherein said first dimension and said second dimension relate to encrypting a message.

9. The method of claim 7 wherein said first dimension and said second dimension relate to digitally signing a message.

10. An apparatus comprising means for performing the method of claim 1 for constructing a multidimensional multistate user interface element, said apparatus comprising:
a presentation means which a user can use to perceive a user interface element;
a user interface means which said user can manipulate to interact with said user interface element; and
a computer processor coupled to a memory storing a sequence of instructions for providing said user interface element, defining a first dimension comprising a plurality of first states, defining a second dimension comprising a plurality of second states, identifying a first data source associated with said first dimension, and identifying a second data source associated with said second dimension, whereby said first data source can freely manipulate said first dimension by setting said first dimension to one of said first states, said second data source can freely manipulate said second dimension by setting said second dimension to one of said second states, and said set first dimension and said set second dimension are combined into a composite state, wherein said composite state is represented in said user interface element, and wherein said composite state as represented in said user interface element may be distinguished from any other composite state as represented in said user interface element.

11. A method of configuring security parameters of a message that will be processed by a secure messaging system, said method comprising:
determining a preference by a user for securing a message to be sent to at least one recipient;
determining whether the preference can be validly implemented when the message is sent based on at least one capability of the secure messaging system; and
displaying a multidimensional user interface element that indicates the preference of the user and the at least one capability of the secure messaging system.

12. The method of claim 11, wherein determining the preference by the user comprises determining whether the user intends to digitally sign the message.

13. The method of claim 11, wherein determining the preference by the user comprises determining whether the user intends to encrypt the message.

14. The method of claim 11, wherein determining whether the preference can be validly implemented when the message is sent comprises determining whether the user has been issued a digital certificate.

15. The method of claim 14, wherein displaying the multistate, multidimensional user interface element comprises displaying a multistate, multidimensional user interface element that indicates an issuer of the digital certificate issued to the user.

16. The method of claim 11, wherein determining whether the preference can be validly implemented when the message is sent comprises determining whether the user has been issued at least one key.

17. The method of claim 11, wherein determining whether the preference can be validly implemented when the message is sent comprises determining whether at least one recipient of the message has been issued at least one key.

18. The method of claim 11, wherein determining whether the preference can be validly implemented when the message is sent comprises determining whether all recipients of the message have been issued at least one key.

19. The method of claim 11, wherein determining the preference by the user for securing the message comprises determining a preference by the user for securing a S/MIME message.

20. An apparatus comprising means configured to perform the method of claim 11, said apparatus comprising:
means for determining a preference by a user for securing a message to be sent to at least one recipient;
means for determining whether the preference can be validly implemented when the message is sent based on at least one capability of the secure messaging system; and
means for displaying a multistate, multidimensional user interface element that indicates the preference of the user and the at least one capability of the secure messaging system.
